(19) United States
(12) Patent Application Publication
(10) Pub. No.: US 2009/0084466 A1
(43) Pub. Date: Apr. 2, 2009

(54) GAS TANK ADAPTOR

(76) Inventor: JAMES R. QUIGG, COSTA MESA, CA (US)

Correspondence Address: WALTER A. HACKLER, Ph.D.;PATENT LAW OFFICE, 2372 S.E. BRISTOL STREET, SUITE B, NEWPORT BEACH, CA, 92660-0755, US

(21) Appl. No.: 11/863,937

(22) Filed: Sep. 28, 2007

(51) Int. Cl. B67D 5/06

(52) U.S. Cl. 141/392

(57) ABSTRACT

An automobile gas tank adaptor includes a cylindrical element having a bottom with an aperture and a side wall extending outwardly from the bottom. A plurality of spaced apart holes are disposed in a radial pattern in the bottom about the aperture and at least one pin protruding from the bottom is aligned with the holes in the radial pattern.

Modern automobile gas tank fuel systems provide for reduced gasoline vapor loss. This is typically done by reducing a diameter of the gas tank filler neck. For older vehicles with larger diameter filler necks an adaptor described in U.S. patent application Ser. No. 11/843,607 filed Aug. 22, 2007 to Quigg may be used.

However, some older vehicles have utilized end plates on larger diameter gas tank filler necks which have a central opening, or aperture, for accepting the fill nozzle with a plurality of holes thereabout to provide for venting of the tank while fuel is dispensed thereinto.

Unfortunately, such end plates do not provide adequate displacement of a nozzle collar which enable the dispensing of gasoline or the use of the adaptor described in U.S. Ser. No. 11/843,607. Such modern nozzles have an accordion collar there apart which must be displaced from a nozzle end in order to commence dispensement of gasoline into a gas tank. The displacement of the accordion collar insures positive contact of the collar with the automobile gasoline tank filler neck.

The present invention provides for a automobile gas tank adaptor for use with such automobiles in order to provide efficient coupling with a modern gasoline dispensing nozzles.

### SUMMARY OF THE INVENTION

A automobile gas tank adaptor is provided for an automobile having a gasoline tank filler neck with an end plate having a central opening for a dispensing nozzle with surrounding vent holes in the end plate.

Specifically, the adaptor includes a cylindrical element having a bottom with an inside and outside diameter and a sidewall extending outwardly from the bottom. This side wall has a thickness sufficient to support a gasoline dispensing nozzle collar as the nozzle is pushed through the cylindrical element. A plurality of spaced apart holes are disposed in the bottom for alignment with the vent holes in order to provide venting for a gas tank while being filled. The vented gasoline being vacuumed between the nozzle and the collar.

At least one pin is provided which protrudes from the bottom for engaging one of the vent holes and enabling alignment of the spaced apart holes with the vent holes. Preferably, a plurality of pins are provided which protrude from the bottom and the pins and holes are spaced in a pattern for enabling the pins to engage corresponding vent holes in the automobile gasoline tank filler neck end plate and the holes to be aligned with corresponding vent holes in the end plate not engaged by the pins.

### BRIEF DESCRIPTION OF THE DRAWINGS

The advantages and features of the present invention will be more clearly understood with reference to the following detailed description when considered in conjunction with the appended drawings, of which:

FIG. 1 is a perspective view of an adaptor in accordance with the present invention shown in a spaced apart relationship with an automobile gasoline tank filler neck with an end plate; and

FIG. 2 is a cross sectional view of the adaptor as installed against the gasoline tank filler neck end plate along with a nozzle inserted through the adaptor and into the filler neck with an accordion collar being compressed and displaced from an end nozzle by side walls of the adaptor extending outwardly from a bottom thereof.

### DETAILED DESCRIPTION

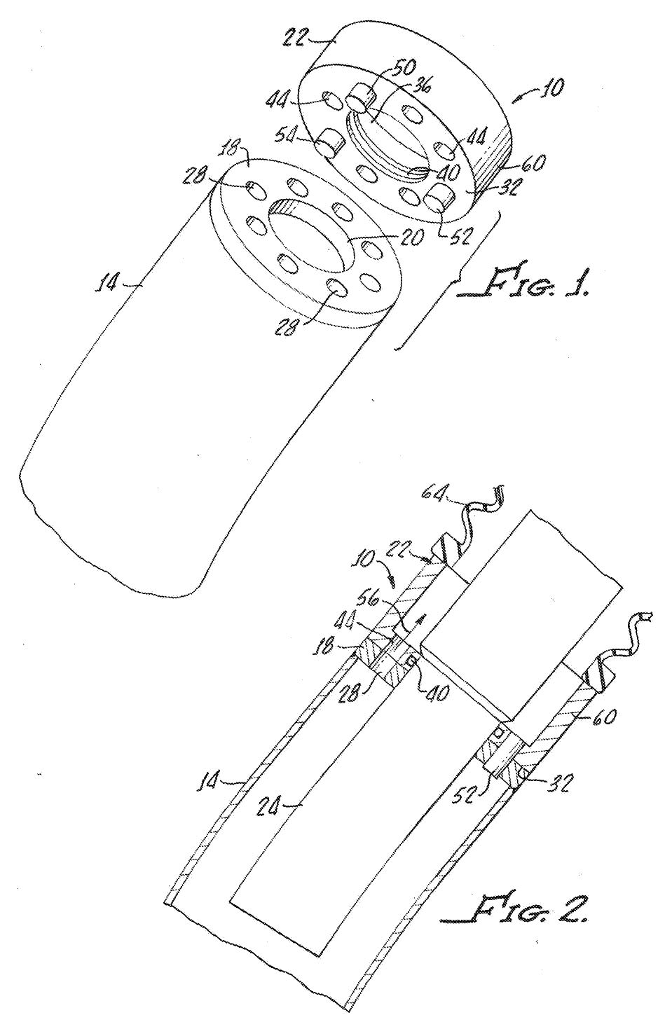

With reference to FIGS. 1 and 2, there is shown an automobile gas tank adaptor 10 for an automobile (not shown) having a gasoline filler neck 14 with an end plate 18 having a central opening 20 for receiving a dispensing nozzle 24, see FIG. 2.

With reference again to FIG. 1, the end plate 18 includes surrounding vent holes 28. As hereinabove noted, the end plate 18 has been used to modify older automobile gasoline tank filler necks 14, such as, for example, older Rolls Royce models.

The adaptor 10 includes a cylindrical element 22 that includes a bottom 32 having an opening 36 for enabling passage of the nozzle 24 therethrough. A gasket 40 provides a seal between the adaptor 10 and the nozzle 24 as illustrated in FIG. 2.

A plurality of spaced apart holes 44 are disposed in the radial pattern in the bottom 32 about the aperture 36 which are alignable with the vent holes 28 when the adaptor 10 is placed in position on the end plate 18 of the fill neck 14, as shown in FIG. 2.

In that regard, at least one pin 50 preferably a plurality of pins 50, 52, 54 protrude from the adaptor bottom 32 and are aligned with the vent holes 28 for engagement therewith and also for aligning the bottom holes 44 with the vent holes 28, as shown in FIG. 2.

Alignment of the holes 44 with the vent holes 28 enables the venting of gasoline vapors from the gas tank (not shown) through the neck 14 as illustrated by the arrow 56.

As shown in FIG. 2 when the adaptor 10 is coupled to the fill neck end plate 18, a side wall compresses an accordion collar 64 surrounding the nozzle 24 which in turn enables the dispensing of gasoline from the nozzle 24 through the fill neck 14. The mechanism and function of this nozzle 24 and collar 64 arrangement is conventional and not part of the present invention.

Although there has been hereinabove described a specific gas tank adaptor in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. An automobile gas tank adaptor comprising:
a cylindrical element having a bottom with an aperture and a sidewall extending upwardly from said bottom;
a plurality of spaced apart holes disposed in a radial pattern in the bottom about said aperture; and
at least one pin protruding from said bottom and aligned with the holes in the radial pattern.

2. The adaptor according to claim one wherein a plurality of pins protrude from the bottom with holes therebetween.

3. The adaptor according to claim 1 wherein said sidewall has a thickness sufficient to support a gasoline dispensing nozzle collar.

4. The adaptor according to claim 1 wherein the pins and holes are spaced apart in a pattern for enabling the pins to engage corresponding vent holes in an automobile gasoline tank filler neck end plate with the holes being aligned with corresponding vent holes in the end plate not engaged by the pins.

5. The adaptor according to claim 1 further comprising a gasket disposed in said aperture for engaging a gasoline dispensing nozzle.

6. An automobile gas tank adaptor for an automobile having a gasoline tank filler neck with an end plate having a central opening for a dispensing nozzle with surrounding vent holes in the end plate, the adaptor comprising:
a cylindrical element having a bottom with an aperture and a sidewall extending outwardly from said bottom;
a plurality of spaced apart holes disposed in the bottom about said aperture for alignment with the vent holes; and
at lest one pin protruding from said bottom for engaging one of the vent holes.

7. The adaptor according to claim 5 wherein a plurality of pins protrude from the bottom with holes in the bottom therebetween.

8. The adaptor according to claim 6 wherein said sidewall has a thickness sufficient to support a gasoline dispensing nozzle collar.

9. The adaptor according to claim 7 the adaptor according to claim 7 wherein the pins and holes are spaced apart in a pattern for enabling the pins to engage corresponding vent holes in the automobile gasoline tank filler neck end plate and the holes to be aligned with corresponding vent holes in the end plate not engaged by the pins.

10. The adaptor according to claim 8 further comprising a gasket disposed in said aperture for engaging the gasoline dispensing nozzle.
